(19) United States
(12) Patent Application Publication
(10) Pub. No.: US 2026/0253039 A1
(43) Pub. Date: Aug. 27, 2026

(54) CRYPTOGRAPHICALLY SECURE, REALTIME EMPLOYEE-WORKER TIMEKEEPING AND REPORTING METHOD AND SYSTEM

(71) Applicant: RealTime Tech Inc, Winter Park, FL (US)

(72) Inventors: Samuel Lu, Mahwah, NJ (US); Jason Schloer, Ashburn, VA (US)

(21) Appl. No.: 19/065,741

(22) Filed: Feb. 27, 2025

(51) Int. Cl. G06Q 10/1091; G06F 21/60; G06K 19/06

(52) U.S. Cl. CPC G06Q 10/1091; G06F 21/602; G06K 19/06037

(57) ABSTRACT

Cryptographically secure, realtime worker timekeeping-reporting system uses worker cell phone, manager cell phone/tablet and server. Both cell phones and tablets use Apps. Worker App generates a first dataset (id, geolocation, timestamp) sent to the server. Server generates a cryptographic marker with worker dataset and generates a two-dimensional barcode (QR) based upon the marker and worker dataset. Worker physically, visually transfers the barcode to manager phone/tablet. Manager's phone/tablet telecommunicates with server, sends manager phone/tablet data with barcode data, manager ID and geolocation (second dataset), and server determines (i) match with cryptographic marker; (ii) match with first dataset and (iii) match with prestored manager ID and geolocation data. Server then generates and sends, to worker, worker confirmation (plus worker ID, etc.) and sends to manager phone/tablet manager confirmation of worker ID, geolocation, and timestamp. Additionally, server stores the worker/manager confirms and timestamps in a secure data store telecommunicatively coupled to the server.

The present invention relates to a cryptographically secure, realtime employee-worker timekeeping and reporting method and system. More broadly, as used in this specification, the term “employee” is meant to cover any type of worker, whether a full-time or parttime employee (also known as W-2 employee), or an independent contractor or a gig worker. In a similar vein, the term “employer” is meant to cover any type of person or entity that seeks to have a worker provide services to that hiring party.

### BACKGROUND OF THE INVENTION

In many industries, accurately tracking employee work hours is critical for ensuring that payroll is processed correctly and efficiently. Traditionally, employers have relied on one of two ways to log the time worked. [A] Paper time slips, using a photocopied form on a piece of paper, where the employee fills out the start and stop times, and the manager signs. [B] Physical time-tracking hardware, such as punch clocks or biometric scanners, located at the worksite, where employees clock in and out by presenting a physical credential, such as a swipe card or fingerprint, which records the start and end of their shifts.

While these systems have been widely adopted, they come with significant limitations. Regarding paper time slips, they sometimes become illegible due to poor handwriting, there is no guarantee of accurate times were entered, and they are easily forged and subject to dispute. This method also requires manual data entry of the information from the form into the payroll system, leading to inefficiencies and another source of error. In connection with physical time-tracking hardware, the installation and maintenance of hardware require substantial upfront investment and ongoing costs. These systems can also be prone to mechanical failure, tampering, or inaccuracies. Additionally, for remote or mobile employees, physical time-tracking hardware can be impractical.

Some prior art systems use QR codes as part of their timekeeping systems. A published Chinese patent application by Guangdong Peanut Information Technology China, CN 104318637, discloses an attendance checking method and system based on a two-dimensional code. The CN '637 attendance checking method includes the following steps: an attendance checking server generates the two-dimensional code and sends the two-dimensional code to a display terminal, wherein the two-dimensional code contains QR code generation date (when the QR was created). A worker-client terminal scans the QR code from the display terminal via the worker's camera.

The worker phone then communicates with the attendance checking server. The attendance checking server verifies the QR, the worker phone device ID, and if verified, the worker's clock-in time is registered and stored in the attendance server.

A similar QR code system is described in China patent application, CN 103473824, by Zhongshan Iker Digital Technology Co. Again, the server generates a two-dimensional code (QR code), the attendance checking server transmits the QR code to the terminal display terminal for displaying the QR image to the worker. The worker's mobile phone scans the QR image and a two-dimensional code identifier in the server separates out QR coded data for the designated business data region and the worker's geolocation data (longitudinal control data and transverse control data), and decodes and decrypts the QR image. Further, the Shenzhen Fangguo Network Technology Co Ltd China patent application, CN 102789584, discloses encoding GPS data of the employee into the data uploaded to the time tracker server.

As discussed below, the present invention is significantly different from these QR code-based attendance timekeeping systems. For example, the prior art systems do not ensure that the QR code generated by the attendance server has anything to do with the worker's phone which receives the server-generated QR code. Hence, this is one potential security or data integrity breach. Prior art systems do not link the worker's phone to the generation of the server-generated QR code.

Another distinction and potential security or data integrity breach is that the prior art systems do not endure that the terminal scanning the worker displayed QR code is the proper, approved scanning terminal. Expanding these prior art systems to larger facilities, with many workers and many managers, each manager having administrative control over a subset of the on-site workers, prior art systems cannot match the proper designated manager, scanning the worker displayed QR code, with the worker in realtime. Post data capture corrections at the attendance server side delay the entire time collection and accounting system. Managers need immediate confirmation that the worker is ON-Shift at the correct location, when the manager scans the worker generated and displayed QR code.

### SUMMARY OF THE INVENTION

The invention provides a specific data processing, cryptographic, secure, realtime employee-worker timekeeping and reporting method and system that overcomes the aforementioned disadvantages. The improved data process for the timekeeper report is sequential data generation, transmission and defined sequence to achieve the cryptographically secure, realtime, employee-worker timekeeping and reporting method and system.

It is an object of the present invention to provide a completely software-based solution that replaces physical time-tracking hardware with smartphone applications, offering greater flexibility and accuracy in time tracking while reducing costs and maintenance. By leveraging smartphone capabilities, the system allows for secure and verifiable time tracking without the need for dedicated hardware.

It is another object of the present invention to employ strict security protocols for communications involving (i) the use of cryptographic signatures or markers to insure that data is accurately collected (from the employee/worker), (ii) visually transmitted to the manager/supervisor, (iii) gathering from the manager/supervisor phone or tablet, specific data over and above the visually transmitted data from the worker, and (iv) confirming the accuracy of several data sets transmitted independently to the timekeeping server from both the employee's and the manager's internet connected devices.

It is a further object of the present invention to provide an improved data collection, data handling, and data security method and system for a timekeeping system. As explained later, the improved timekeeping data collection begins with adding a cryptographic marker or signature to initially collect data from the employee/worker (the marker including representations of the initially collected data). Then, at a later time, confirming the cryptographic marker, signature or keycode to ensure the first acquired worker data matches, within reason, the later acquired manager data. The first acquired data obtained, in one embodiment, by an App on the employee/worker cell phone, and the later acquired data obtained, via an App on the manager/supervisor cell phone or tablet. The use of one or two cryptographic markers, signatures or keycodes ensures that data ultimately acquired by and stored in the timekeeping server is accurate, genuine and not corrupted or otherwise compromised by the worker or manager.

The present invention relates to a system and method for verifying employee (that is, a worker) work times using, in one embodiment, a pair of smartphone Apps, eliminating the need for traditional physical time-tracking hardware. The system comprises two smartphone applications—one for the employee-worker and one for the manager. Those Apps communicate with a centralized server hosted by a Service Provider (“SP”). The employee's application or App communicates with the SP server and the server generates a cryptographically signed QR code containing employee and shift data, and the worker phone's GPS location (geolocation data). The employee or worker then displays the encoded QR code to the manager and the manager's phone then scans the QR code and triggers the manager's application or App to open and process the visibly presented QR encoded data. The scanned data is transmitted to the Service Provider server, where the server validates the cryptographic signature (earlier generated by the SP server, upon request by the worker's phone) to verify the integrity of the data uploaded by both the worker as well as the manager's phone. The validated shift data, along with worker GPS location, are recorded in a central database (a secure data store distinct from the SP server memory and data stores or databases), ensuring both temporal and locational accuracy for work time tracking. The system provides a secure, efficient, and cost-effective solution for employers and employees to verify worked times without the need for specialized hardware.

The present invention also provides a system and method for manager verified work time tracking using smartphone applications. This eliminates the need for physical hardware such as punch clocks or biometric scanners. One embodiment of the system includes: Employee App: An App that requests a QR code from a centralized Service Provider's server at the start and at the end of a shift. The QR code generated by the SP server contains time data, shift attributes, and a cryptographic signature. This cryptographic signature, generated by the SP server is based upon the data uploaded from the worker cell phone. The Manager App is an App that scans the aforementioned QR code presented by the employee's phone, decodes the embedded information, and sends it back to the Service Provider server. The Service Provider server is a central server that generates QR codes, validates cryptographic signatures, verifies the integrity of data, and records verified shift start and end times in a secure database.

The system utilizes the smartphones' GPS capabilities to further verify that the employee—worker is at the correct work location (geolocation) when they clock in and out (Clock-in; Clock-out), providing an additional layer of accuracy and confidence in the time-tracking process.

With the foregoing and other objects in view, there is provided, in accordance with the invention, a method for operating a cryptographically secure, realtime worker timekeeping and reporting system. In one embodiment, the method is used in conjunction with a worker cell phone, a manager cell phone or tablet (herein “phone/tablet”) and a server, all telecommunicatively coupled together. As used herein, reference to the “manager cell phone” or simply the “manager phone” is meant to include and cover both a manager tablet with the operative functions described hereinbelow as well as a manager cell phone. Both the cell phone and the tablet use an App which operates in a manner described hereinbelow. The worker phone nominally has a display screen and may include a touch screen input surface which also operates as a display screen (worker phone may also have a camera). The manager phone/tablet nominally has a display screen and a camera. The method involves sending a first data set to the server from the worker phone, The first data set includes a worker identifier, a worker geolocation, and a then-current timestamp. The geolocation and timestamp represent realtime data obtained from the worker's phone at the time of App activation. The SP server generates a cryptographic marker (a highly unique key code) unique to at least one or more of the following data: a worker identifier, a worker geolocation, or the timestamp (server may use all such data for the marker). The server generates a two-dimensional barcode (which, in certain situations, is a QR code) based upon the cryptographic marker and at least one or more of the worker identifier, the worker geolocation, or the timestamp. The term “QR code” is used interchangeably herein as a “two-dimensional barcode.” The two-dimensional barcode carries encoded data unique to the server and the collected worker cell phone data. The server sends the two-dimensional barcode to the worker phone. The worker physically presents the worker phone's display (showing the barcode) to the manager's phone/tablet camera and, as a result, visually transfers the barcode from the worker phone to manager phone or tablet. In response to the visually transferred barcode, the manager's phone/tablet establishes a telecommunications link with the server. In a further response, the server obtains, from the manager phone/tablet, a manager identifier and the two-dimensional barcode (and sometimes geolocation and manager timestamp). Thereafter the server decodes the barcode data to obtain, among other things, a decoded cryptographic marker. The server determines whether the decoded cryptographic marker matches the original cryptographic marker. If a match is confirmed, the server validates the first data set, the worker identifier, the worker geolocation, and the timestamp and also verifies the manager identifier and other manager data, if any. In one embodiment, the manager App transfers the manager identifier in the two-way communication with the server, triggered by the QR code or barcode. After validation/confirmation, the server generates and sends, to the worker phone, a worker confirmation of one or more of the worker identifiers, the worker geolocation, and the timestamp. The server also generates and sends, to the manager phone/tablet, a manager confirmation of the worker identifier, the worker geolocation, and the worker timestamp. Additionally, the server stores the worker confirmation data, the manager confirmation data, the manager identifier, the worker identifier, the worker geolocation, and the worker timestamp in a secure data store telecommunicatively coupled to the server.

From the system-wise perspective, one embodiment of the present invention is a cryptographically secure, realtime worker timekeeping and reporting system involving a worker cell phone, a manager cell phone/tablet and a server, all telecommunicatively coupled together via a network. The worker phone has a phone display screen, a worker phone processor and memory. The worker processor compiles a worker data set including a worker phone device ID, a current worker geolocation, and a worker current timestamp from data stored in the worker memory and the worker time clock. The worker processor sends the worker data set to the server via the network. The server has a server processor accessing a server memory preloaded with a stored worker phone device ID, a stored prescient worker geolocation, a stored worker clock-in time, and a stored manager phone device ID. A match module, associated with the server processor and the server memory, (a) confirms the worker phone device ID with the stored worker phone device ID, (b) substantially confirms the current timestamp with the stored worker clock-in time; (c) substantially confirms the current worker geolocation with the stored prescient worker geolocation. The term “substantially confirms” includes the concept that the worker's timestamp or Clock-in data must be different than the manager's phone/tablet timestamp. Hence, “substantially confirms” means that some reasonable time differentials are accounted for by the method and the system. The same concept applies to geolocation because the geolocation of the worker may be different than the geolocation of the manager, especially if the worker and manager are located in different parts of the building or work location.

This embodiment of the cryptographically secure, realtime worker timekeeping and reporting system may further include a match module in the server, (d) upon such confirmation of items a-c above, which generates an initial worker ON shift status. A cryptographic generator, associated with the server processor and the server memory, generates a cryptographic marker based upon one or more of the worker phone device ID, the current worker geolocation or the initial ON shift status. The server processor, in conjunction with the cryptographic generator, generates a two-dimensional barcode representation with the cryptographic marker and the one or more of the worker phone device ID, the current worker geolocation or the initial ON shift status. The worker phone processor receives and stores the two-dimensional barcode representation and, under the control of the worker, permits the worker to activate the worker phone display to project a lighted two-dimensional barcode based upon the two-dimensional barcode representation. In other words, the QR code is displayed on the worker phone display which illuminates the camera in the manager's phone/tablet.

In this embodiment, the manager phone/tablet has a manager display screen and a camera, a manager processor and a manager memory. When the worker phone is adjacent to the manager phone/tablet, the lighted two-dimensional barcode illuminates the manager camera and thereby visually transfers the two-dimensional barcode from the worker phone to manager phone/tablet. The lighted two-dimensional barcode triggers the manager phone/tablet processor to generate a manager data set including a manager device ID, a manager timestamp, a captured representation of the visually transferred two-dimensional barcode. This manager data is sent to the server either by the App or under temporary control of the server. The server has a cryptographic decoder, coupled to the server processor, which receives and decodes the captured two-dimensional barcode and the encoded worker data set and then generates a representation of the cryptographic marker and a decoded worker data set. The match module, in the server, authenticates (i) the decoded worker data set by comparing the representation of the cryptographic marker with the cryptographic marker, and (ii) the manager data set by comparing the stored manager phone device ID with the manager phone device ID. The server processor validates the initial worker ON shift status as a validated worker ON shift status based upon the match module authenticating the decoded worker data set, the cryptographic marker, and the manager data set. The server processor then sends to the worker phone the validated worker ON shift status. The server processor also sends to the manager phone/tablet the validated worker ON shift status.

In accordance with another feature, an embodiment of the present invention includes a server memory which has preloaded stored worker shift data therein including pay rate data and shift worker requirement data. In this further embodiment, the server processor, upon generation of the validated worker ON shift status, generates a worker validation data set including a worker identifier, the current worker geolocation, the worker current timestamp, the pay rate, and the shift worker requirements, and sends the worker validation data set to the worker phone. The server processor also sends the worker validation data set with the validated worker ON shift status to the manager phone or tablet.

A more fulsome description of the cryptographically secure, realtime worker timekeeping and reporting system operates in combination with a worker cell phone, a manager cell phone or tablet and a server, all telecommunicatively coupled together via a network. The worker phone has a worker display and the manager phone or tablet has a manager display screen and a camera. In this embodiment, a worker phone processor compiles a worker data set including a worker identifier, a worker phone device ID, a current worker geolocation, a worker shift data, and a worker current timestamp stored in a worker phone memory. The worker phone interface sends the worker data set to the server via the network. The server has a server processor accessing a server memory preloaded with a stored worker identifier, a stored worker phone device ID, a stored prescient worker geolocation, a stored worker shift data, a stored worker clock-in time, a stored manager identifier data, and a stored manager phone device ID. The server also has a server network interface accepting the worker data set. The server's match module, operating with the server processor, (a) confirms the worker identifier, the worker phone device ID, and the worker shift data with the stored worker identifier, the stored worker phone device ID, and the stored worker shift data; (b) substantially confirms the current timestamp with the stored worker clock-in time; (c) substantially confirms the current worker geolocation with the stored prescient worker geolocation; and (d) generates an initial worker ON shift status. The server has a cryptographic generator (C-generator), coupled to the server processor, operating on one or more of the worker identifiers, the worker phone device ID, the worker shift data, the current worker geolocation or the initial ON shift status. The C-generator generates an encoded worker data set and a cryptographic marker which are all embodied by a two-dimensional barcode representation. The server network interface sends this two-dimensional barcode representation to the worker phone interface via the network. The worker phone processor stores the two-dimensional barcode representation and activates the worker phone display to project a lighted two-dimensional barcode based upon the two-dimensional barcode representation. The lighted two-dimensional barcode is positioned to illuminate the manager camera and thereby visually transferring the two-dimensional barcode from the worker phone to manager phone or tablet.

The manager phone or tablet has a manager network interface and, in response to the lighted two-dimensional barcode, the phone/tablet establishes a telecommunications link between the manager phone or tablet and the server via the network. The manager's phone/tablet has a manager processor generating a manager data set including a manager identifier, a manager device ID, a manager timestamp, a captured representation of the visually transferred two-dimensional barcode, and sending the manager data set to the server via the manager network interface. The server has a cryptographic decoder (C-decoder), coupled to the server processor, decoding the captured two-dimensional barcode and the encoded worker data set. The C-Decoder generates a representation of the cryptographic marker and a decoded worker data set. The server processor stores, in the server memory, the manager data set, the generated representation of the cryptographic marker, and the decoded worker data set. The server's match module authenticates (i) the decoded worker data set by comparing the representation of the cryptographic marker with the cryptographic marker, (ii) the collected worker data with the preloaded worker data; and (iii) the manager data set by comparing the stored manager identifier data and the stored manager phone device ID with the manager identifier data and the manager phone device ID. The server processor further validates the initial worker ON shift status as a validated worker ON shift status based upon the match module authenticating the decoded worker data set, the cryptographic marker, and the manager data set. The server stores, in the server memory, the validated worker ON shift status with the decoded worker data set and the manager data set. The server processor then sends to the worker phone, via the server network interface, the validated worker ON shift status. The server processor also sends to the manager phone or tablet, via the server network interface, the validated worker ON shift status.

Further embodiments and enhancements of the method include generation of a cryptographic marker which is unique to the worker identifier, the worker geolocation, and the timestamp. Further, the server generates the two-dimensional barcode based upon the cryptographic marker, the worker identifier, the worker geolocation, and the timestamp. All this is encoded in the QR code or barcode. Additionally, the worker identifier may be a worker name, a employer issued id, or a worker's phone device ID. The manager identifier may be a manager name, a manager issued id, or a manager's phone or tablet device ID. The employer issued id is an identification card, badge or token issued to the worker by the employer or contracting party. The manager issued id is an identification card, badge or token issued to the manager by the employer or contracting party.

Additional features of the present invention include a worker's phone with a phone camera. The worker identifier may be a employer issued id (an id issued by the facility where the worker is providing services) and a manager identifier as a manager issued id. In this embodiment, the worker scans the facility issued id with the worker's phone camera and in response the server generates the cryptographic marker based upon the employer issued id. Also, the manager scans the manager issued id with the his/her phone/tablet camera, and the server obtains the manager issued id and verifies the manager issued id while validating the first data set.

Another modification of the present invention is a server having a server data store distinct from the secure data store. This embodiment includes the server data store storing the worker identifier, a worker name, a employer issued id, and a worker's phone device ID. The server data store also stores preloaded worker shift data, preloaded worker geolocation data for the shift, and preloaded facility data for the preloaded worker shift. The server data store also stores the manager identifier, a manager name, and a manager's phone device ID and stores preloaded manager shift data. When the first data set is sent to the server, the server obtains the worker's phone device ID to determine a match with the stored worker's phone device ID, and a proximate match with the preloaded worker shift data and the worker's timestamp. The match uses the processor and the stored data in the memory. Also, the server proximately matches the worker geolocation with either the preloaded worker geolocation data for the shift or the preloaded facility data for the shift. Once the first data set matches the preloaded data and the stored worker's phone device ID, the server generates the cryptographic marker and the two-dimensional barcode. Again, at the server, a determination or validation of the first data set is made by proximately matching the worker geolocation and preloaded worker geolocation data for the shift and proximately matching the preloaded facility data, and proximately matching the timestamp with the preloaded worker shift data, and matching the worker's phone device ID with the stored worker's phone device ID. The server, in this verifying step, verifies the manager identifier by proximately matching the worker timestamp with the preloaded shift data which includes the manager ID.

In another embodiment, the server generates and sends, to the worker phone, the worker confirmation, the worker name, the worker identifier, the employer issued id, the worker geolocation, and the timestamp. The server then generates and sends, to the manager phone or tablet, the manager confirmation of the worker identifier, the worker geolocation, the timestamp and the preloaded worker shift data, and further sends the manager identifier and the manager name to the manager.

Additionally, the preloaded worker shift data may include skills required data and worker pay rate data. In this configuration, the server, in addition to sending the manager confirmation of the worker identifier, the worker geolocation, and the timestamp, also sends the worker name, the worker assigned id, the skills required data and the worker pay rate data.

Although the invention is illustrated and described herein as embodied in a cryptographically secure, realtime employee-worker timekeeping and reporting method and system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skills in the art to variously employ the present invention in virtually any appropriately detailed structure. Further, the terms and phrases used herein are not intended to be limiting; but rather, to provide an understandable description of the invention. The Abbreviations Table near the end of this patent specification provide a general conception of the meaning of the abbreviation and such definitions are only exemplary of the structure, function and characteristics of the term. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” or “connected” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the description of the embodiments of the present invention, terms such as “first,” “second,” “third,” and so on are only used for descriptive purposes and cannot be construed as indicating or implying relative importance. In the description of the embodiments of the present invention, it should be noted that, unless otherwise clearly defined and limited, terms such as “coupled,” “connected” should be broadly interpreted, for example, it may be fixedly connected, or may be detachably connected, or integrally connected; it may be mechanically connected, or may be electrically connected; it may be directly connected, or may be indirectly connected via an intermediate medium. The terms “program,” “App,” “software application,” and the like as used herein, are defined as a sequence of instructions designed for execution on a computer system. A “program,” “computer program,” “App,” or “software application” may include a subroutine, a function, a procedure, an object method, an object implementation, an executable application, an applet, a servlet, a source code, an object code, a shared library/dynamic load library and/or other sequences of instructions designed for execution on a computer system. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 diagrammatically illustrates a data flow or processing diagram showing the operations of an embodiment of the present invention.

FIG. 2 diagrammatically illustrates a data flow or processing diagram with a validation process showing the operations of an embodiment of the present invention.

FIG. 3 diagrammatically illustrates a block diagram showing major components of an embodiment of the present invention.

FIG. 4 diagrammatically illustrates a block diagram showing additional components of an embodiment of the present invention.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient cryptographically secure, realtime employee-worker timekeeping and reporting method and system. At a high level, one embodiment of the present system operates as follows. (A) Work Start/End and QR Code Generation: The employee/worker uses the Employee App to indicate that he/she is ready to start or end the work. The app requests a unique QR code from the Service Provider server when beginning or ending their shift. The Service Provider server generates the QR code, which contains the current time, shift ID, and various shift attributes such as skills required and pay rates. This information is cryptographically signed by the server, using the Service Provider's credentials, to ensure data integrity and security. The QR code is then displayed on the Employee/Worker App, and presented to the Manager to scan. (B) Manager Scan and Server Validation: The manager or supervisor scans the QR code using the Manager App, which decodes the data and transmits it back to the Service Provider server. The Service Provider server validates the cryptographic signature, the timeliness of the data, and verifies the data's integrity by comparing it with the original information sent to the Employee App. (C) Time Logging and Data Storage: Upon successful validation, the Service Provider server records the current time as the verified start or end time of the employee's shift. The GPS data of the employee's smartphone is also recorded to verify their physical presence at the worksite. All of this information is stored in a central database managed by the Service Provider.

The present invention employs a set of security measures to confirm data transmission and source accuracy. (D) Cryptographic Signatures: Ensure that the data encoded in the QR code has not been altered after its creation. It also prevents anyone other than the Service Provider from generating a valid QR code. (E) Location Tracking: Ensure that the employee is at the work location while presenting the QR code. (F) Data Comparison: The Service Provider compares the decoded data from the Manager App with the original data sent to the Employee App, ensuring that the information has not been tampered with or compromised. (G) Centralized Data Storage: Validated shift data and associated GPS coordinates are securely stored in a central database for auditing, payroll, or reporting purposes.

In general, the system verifies employee work times with an employee/worker smartphone application (App) configured to request, receive, and display a cryptographically signed QR code from a Service Provider (SP) server, wherein the QR code includes time data, shift attributes, and a signature. A manager smartphone application (App) is configured to scan the QR code presented by the employee smartphone application, decode the embedded information, and transmit the decoded information back to the Service Provider server for validation. The Service Provider server is configured to generate the QR code containing the time data, shift attributes, and cryptographic signature. The server validates the crypto signature and verifies the integrity of the decoded data received from the manager smartphone application. The server records the validated time data and related shift attributes including GPS location in a central database.

Further enhancements to the system include the cryptographic signing of the QR code, generated based on the current time, a unique shift identifier, and associated shift attributes including skills required, pay rates, and other metadata relevant to the work performed by the employee. Another enhancement is Service Provider server comparing the decoded data received from the manager smartphone application with the original data sent to the employee smartphone application to detect any potential tampering or errors during transmission. Additionally, the GPS location data (both at the worker initial data acquisition and at the manager scan and upload time) is recorded at both the start and end of the shift and stored alongside the time data in the central database, providing additional verification of the employee's physical presence at the worksite.

Another refinement of the invention includes generating a QR code on an employee's smartphone application, the QR code including time data, shift attributes, and a cryptographic signature provided by a Service Provider server. The QR code is scanned on a manager's smartphone application, decoding the time data and shift attributes, and transmitting the decoded information to the Service Provider server for validation. At the server, a validation of the cryptographic signature and verification of the integrity of the decoded information is made by the Service Provider server. The server also records the start and end times of the employee's shift, along with the GPS location data, in a central database managed by the Service Provider.

Once the verification process is completed using only smartphone applications, this eliminates the need for any specialized hardware, such as physical punch clocks or biometric scanners. The method uses GPS location data to ensure that the employee was present at the designated worksite during the shift, adding an additional layer of verification to the time-tracking process.

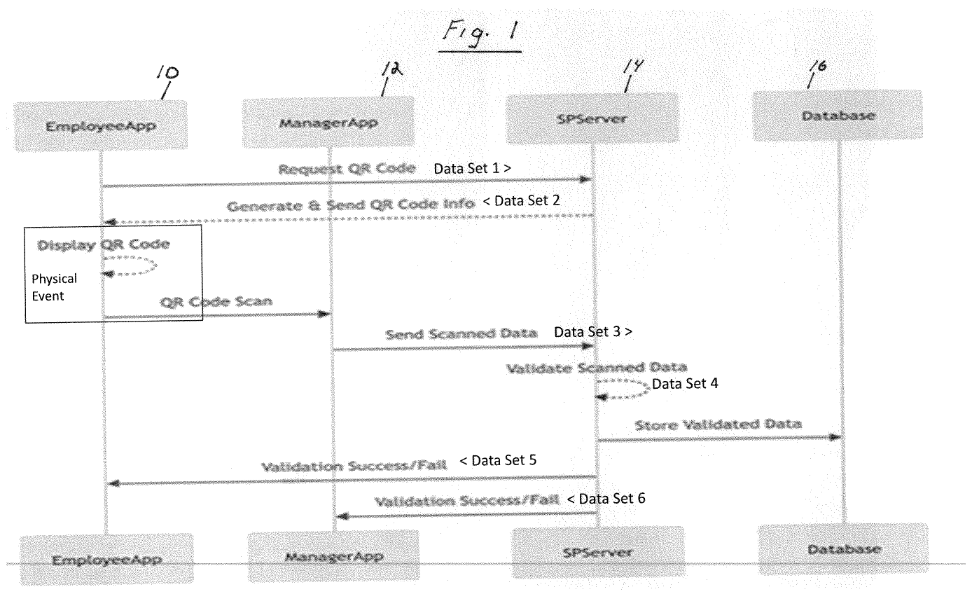

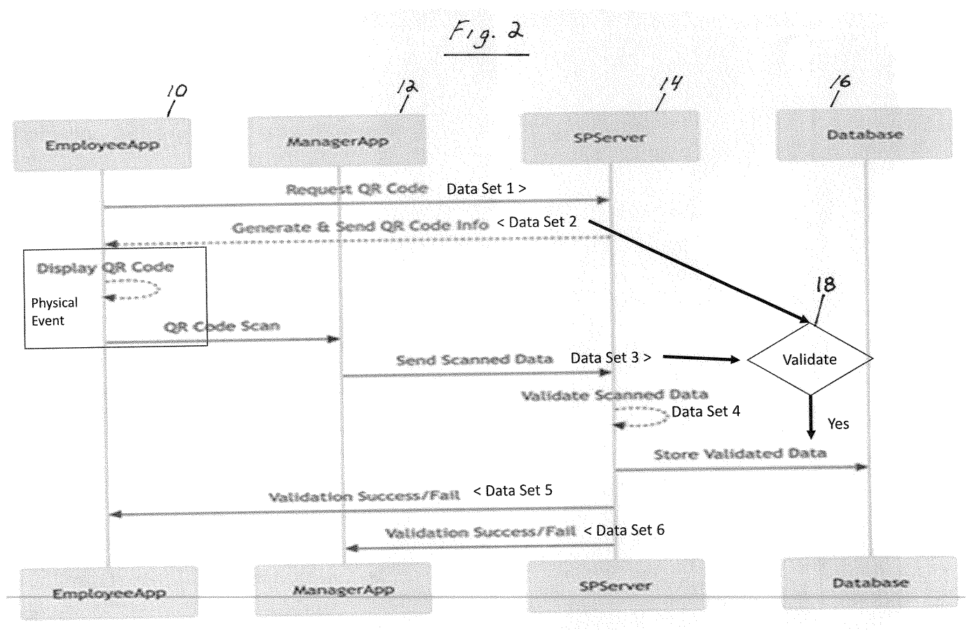

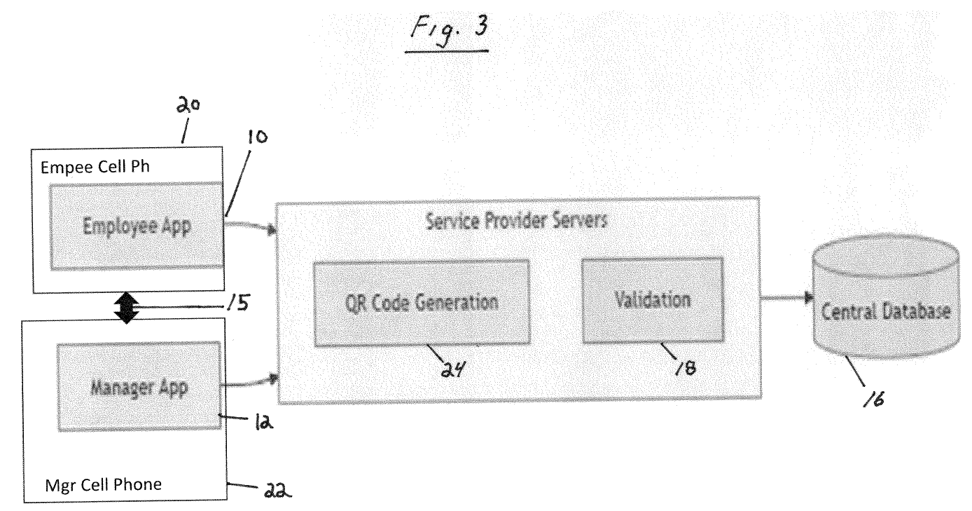

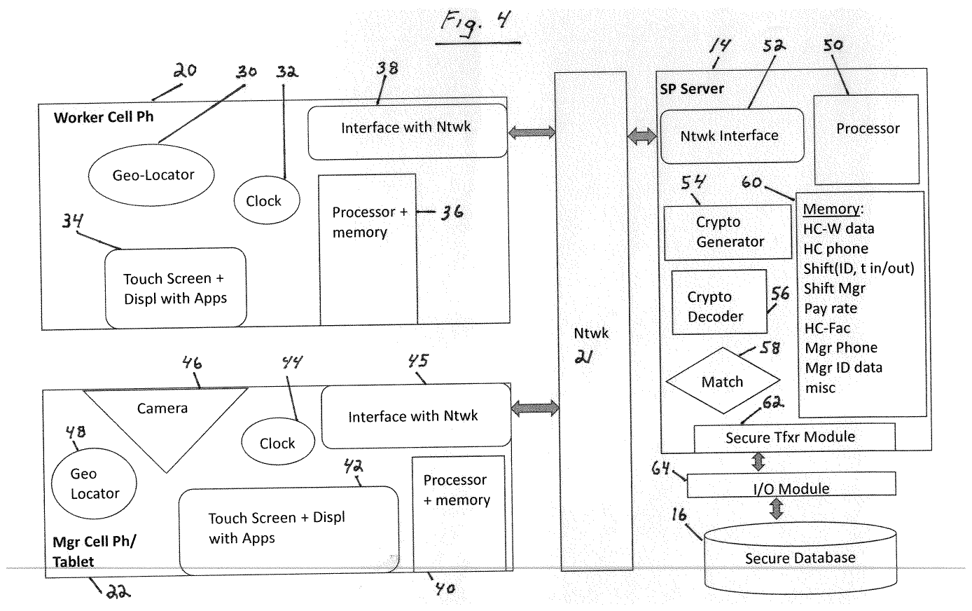

FIGS. 1 and 2 diagrammatically illustrate a data flow or processing diagram showing the operations of an embodiment of the present invention. FIG. 3 diagrammatically illustrates a high-level block diagram showing major components of an embodiment of the present invention and FIG. 4 diagrammatically illustrates a more comprehensive block diagram showing components of an embodiment of the present invention. The components of the realtime employee-worker timekeeping and reporting method and system in FIGS. 3 and 4 are initially discussed below. Thereafter, the data processes in FIGS. 1 and 2 are discussed.

FIGS. 1 and 2 diagrammatically illustrate data processes between employee/worker App 10, manager App 12, Service Provider “SP” server 14, and secure central database 16. As explained later in connection with FIG. 4, server 14 has its own memory, data store or database, different and distinct from central, secure database 16. FIG. 2 diagrammatically illustrates the data process in accordance with an embodiment of the invention and particularly the validation or match function 18. The data flow processes in FIGS. 1 and 2 are discussed in detail later.

FIG. 3 diagrammatically shows a high-level component diagram of an embodiment of the present invention. The employee-worker cell phone 20 carries an employee App 10. The manager cell phone or tablet 22 carries a manager App 12. As discussed later, the employee, on his or her cell phone 20, visually transmits or transfers a lighted two-dimensional barcode, sometimes referred to as a QR code, to the camera on manager cell phone or tablet 22. This visual or light transmission is illustrated in FIG. 3 by the double headed arrow 15. The SP server 14 includes a QR code generator 24 and a validation module 18. As explained later, when data collected from the worker and the later acquired data from the manager is confirmed as being accurate by the SP server 14, this data is uploaded to central secure database 16 by the service provider SP server 14.

FIG. 4 diagrammatically illustrates a more detailed component system in accordance with an embodiment of the present invention. FIG. 4 shows worker cell phone 20 communicating with telecommunications network 21. Manager cell phone or tablet 22 also is communicative coupled to network 21. SP server 14 is connected or coupled to network 21. In this manner, worker cell phone 20 and manager cell phone/tablet 22 and server 14 communicate via network 21 worker network interface 38, manager network interface 45 and server network interface 52. The double headed arrows from network 21 to these components indicate this telecommunications connection. With respect to central secure database 16, the telecommunication interconnect involves the secure transfer module 62 from the SP server 14 through input/output I/O module 64 permitting communication between server 14 and secure central database 16. As indicated earlier, similar numerals designated similar items in all the drawings.

It should be noted that although SP server 14 includes a memory data store (maybe a database plus onboard processor-memory), and central secure database 16 is shown as being a separate memory component as compared with data store/memory 60, the SP server 14 and the central secure database 16 may be maintained online in a cloud computing system which also includes a segmented memory store 60 dedicated to SP server 14 and a separate, high-security database or data store 16 also maintained in the cloud computing system. It is known that cloud-based servers may access multiple different data stores or databases and these data stores may have different security level access controls. Therefore, the separate identification of data store 60 in SP server 14 in contrast to secure database 16 may be defined in a cloud-based server system.

Worker cell phone 20 includes a processor and a memory 36 which is coupled or interacts with worker cell phone network interface 38, clock 32, and geolocator 30. As is common, the cell phone 20 has a touch screen display 34 and the worker, possessing cell phone 20, can activate Apps on his or her cell phone by utilizing the touch screen display 34. Clock 32 generates a timestamp for the activity commanded and initiated by activation of the worker App. Worker cell phone 20 generates a timestamp based upon the timekeeping App earlier stored on the worker's cell phone. Processor 36 obtains geolocation data from geolocator 30 and also provides that geolocation data as commanded by the worker timekeeping App. In some embodiments of the present invention, the worker cell phone includes the camera which enables the worker to scan a facility-issued worker ID, called a “employer issued ID.” The camera, not shown in FIG. 4, is similar to camera 46 in the manager cell phone/tablet 22.

The manager cell phone or tablet 22 includes a manager network interface 45 which communicates with telecommunications network 21, a clock 44, a camera 46, a processor and memory subsystem 40, and a touch screen and display 42. The manager phone/tablet 22 also includes a timekeeping App used in some embodiments of this invention.

SP server 14 includes a server network interface 52, a processor 50, a cryptographic generator 54, a cryptographic decoder 56, a matching function or module 58, a memory data store 60 (which may include a database), and a secure transfer module 62. As explained earlier, the secure transfer module 62 communicates with input/output I/O data module 64 to establish a data communication pathway between server 14 and secure central database 16. It should be noted that generator 54, decoder 56 and match function 58 represent computer programs or sub-programs activated by processor 50 in server 14. Typically, they are not discrete hardware devices. These sub-programs are maintained in memory 60. Therefore, the identification of these components 54, 56 and 58 represents software functions. Typically, these functions 54, 56, 58 are not separate components in server 14. However, in certain situations, certain hardware configurations of the timekeeping system may utilize separate components for generator 54 and decoder 56. Also, generator 54 and decoder 56 may include processors which speed up the cryptographic functions.

Returning to data processing flow charts in FIGS. 1 and 2, Data Sets 1-6 represent data transfers between worker App cell phone 10, manager App cell phone/tablet 12, SP server 14 and the central secure database 16. The claims appended hereto list nominal data collections in data sets 1-6. This nominal transferred data is included in the discussion of Data Set 1-6 below. It should be noted that the system operator can add or delete certain data to be gathered, processed, transferred, and reprocessed, however the claims define the nominally required data to be gathered, transferred, and processed and, in some cases, cryptographically condensed to insure a secure, immutable data collection and timekeeping transfer.

The following Data Set-Process Flow Table is an exemplary collection of data for Data Sets 1-6.

Data Set - Process Flow Table
Data Set 1: Empee Name/Ph; Empee GeoLoc; Empee T-stamp
Data Set 2: 1st Crypto-Siggy; e-Empee Name/Ph; e-Empee Shift; e-
Empee GeoLoc; e-Empee T-stamp; e-Empee H-Fac (optional); misc
data (encrypt); Data Set 2 embodied in a QR code
Physical Event: Display QR code on Empee Ph, representing Crypto-
Siggy; Empee Name/Ph; Empee Shift; Empee GeoLoc (optional);
Empee H-Fac (optional); Empee T-stamp; misc data
Data Set 3: Data Set 2 as represented by QR code PLUS Mgr Name/Ph;
Mgr GeoLoc; Mgr T-stamp; 2nd Crypto-siggy (optional)
Data Set 4: Decode and Validate: Both 1^{st} and maybe 2^{nd} Crypto-Siggy;
Empee Name/Ph; Empee Shift; Empee GeoLoc; Empee T-stamp; Mgr
Name/Ph; Mgr GeoLoc; Mgr T-stamp; misc
Data Set 5: Empee Name/Ph; Clock-in T Confirm (or Clock-out T);
Empee Shft; H-Fac Loc Data (optional)
Data Set 6: Mgr Name/Ph; Empee Name; Empee Clock-in/out T
Confirm; Empee Shft; H-Fac Loc Data (optional)

A nominal data collection for Data Set 1 is: Empee Name/Ph or Empee device ID; Empee GeoLoc; Empee T-stamp (employee is the same as a worker). An enhanced Data Set 1 is a worker identifier, a worker name, a worker issued id (issued by the employer or contracting party who hired the worker), or a worker's phone device ID. This nominal data set is auto-generated by the worker phone 20 (FIG. 3) by worker App 10 (FIG. 3). The phone device ID or phone/tablet device ID is commonly used to identify one user's cell phone/tablet from another phone/tablet. Each internet or telecommunications enabled device has a separate “device ID.” The nominal data collection for Data Set 3 is a manager identifier and a decoded cryptographic marker or a representation of the two-dimensional barcode (typically a QR code). The manager identifier may be either the phone/tablet device ID or other electronic manager identifier, electronically obtained from the phone/tablet 22 (FIG. 3) by the manager App 12 (FIGS. 1 and 3). The “decoded cryptographic marker” is a representation of the crypto signature or crypto marker sent in Data Set 2 from the server 14 to the worker cell phone 20 or a representation of the 2-D bar code or QR code. The nominal data for Data Set 5 is the “Clock-in T Confirm” or a worker confirmation of one or more of the worker identifiers, the worker geolocation, and the timestamp earlier acquired in Data Set 1 transfer from employee cell phone 20 (via App 10) to server 14. The Clock-in T Confirm is also a validated worker ON shift status signal. These ON shift or Clock-in Confirms are designed to be displayed on the worker's cell phone 20.

The Exemplary Process Flow Table and the Process Flow Table (Expanded) below lists other data collections for Data Sets 1-6. The server, to generate Data Set 2, nominally uses Data Set 1 which is at least one or more of the worker identifier, the worker geolocation, or the timestamp (acquired from the worker's phone 20 at data collection time commanded by App 10). Data Set 2 includes a crypto marker, signature (“siggy”), or keycode which is a hash of SP server data or hardware embedded data and Data Set 1, or a portion of Data Set 1. The worker identifier in Data Set 1 may be an assigned identifier, a worker name, a worker “issued id,” or a worker's phone device ID. The worker geolocation data is from geolocator 30 of phone 20 (FIG. 4). The worker timestamp is from the clock in the cell phone. The timestamp upon activation of the App is stored in the cell phone memory. The crypto marker, signature (siggy), or keycode is, typically, a hash of some data from the server 14 (like the server timeclock or server timestamp, showing the receipt time of Data Set 1 from the worker or the generation time of the crypto key/marker). Other cryptographic functions or algorithms, other than a hash, may be used. It is known that crypto keys use (i) data or device embedded codes from one machine and (ii) hash that data with another data set, which, in this embodiment, is data from the worker cell phone 20. That “other data set” for the hash is nominally one or more of the worker identifier, the worker geolocation, or the timestamp. However, the typical hash would use more worker data transmitted in Data Set 1 such as: Worker Data Set 1 including a worker phone device ID, a current worker geolocation, and a worker current timestamp. The phone device ID is highly secure and valid datapoint to clearly identify the “sending” phone which transmits the data. The geolocation data places the worker at the designated facility (in a healthcare or “HC” system, the HC-Fac identifies the HC facility or building where the worker or manager is located. See the Abbreviations Table near the end of this specification). The collected geolocation data is another security function of the timekeeping invention.

The server 14 generates a two-dimensional barcode (which, in certain situations, is a QR code) based upon the sever-generated cryptographic marker and at least one or more of the worker identifier, the worker geolocation, or the timestamp. Herein, the reference to “QR code” refers to any type of two-dimensional barcoding systems. The QR code carries encoded data unique to the server and the worker cell phone. The server sends the QR code to the worker phone in Data Set 2. As discussed above, the QR code effectively encrypts the crypto marker and some worker-supplied data from Data Set 1.

As noted in FIGS. 1-4, the worker physically places worker phone's display 34 (showing the QR barcode) proximate the manager's phone/tablet camera 46, and, as a result, visually transfers the QR code from the worker phone 20 to manager phone/tablet 22. In response to the visually transferred QR barcode, the manager's phone/tablet establishes a telecommunications link with the server which initiates the transfer of Data Set 3. This transfer may be a single communication or, most likely, one of several data communications between phone/tablet 22 and server 14. The multiple communications are facilitated by server 14. In response to the activation of the QR code on phone/tablet 22, the server obtains, from the manager phone/tablet, a manager identifier (most likely, the manager device ID (a high security function) and a representation of the two-dimensional barcode or QR code. For example, the received lighted QR code may cause the manager cell phone/tablet 22 to automatically contact server 14. Server 14 may then cooperate with the manager App 12 to extract manager data from the phone/tablet 22, such as device ID, manager name, manager geolocation, and manager timestamp.

Thereafter the server decodes the QR barcode with decoder 56 (FIG. 4) to obtain, among other things, a decoded cryptographic marker. The server determines whether the decoded cryptographic marker matches the cryptographic marker originally sent by the server to the worker phone 20 in Data Set 2. If a match is confirmed with match function 58 (FIG. 4), the server validates the first data set (validator 18; match 58), the worker identifier, the worker geolocation, and the timestamp and also verifies the manager identifier. In one embodiment, the manager App transfers the manager identifier in the two-way communication with the server, triggered by the QR code or barcode.

As shown in FIG. 2, server 14 compares several datapoints from Data Set 1 with data from Data Set 3 and with validate function 18 (FIG. 2) or match function 58 (FIG. 4). As noted by the different Data Sets 1-6 in the Data Set-Process Flow Table above or the Exemplary Process Flow Table below or the Process Flow Table (Expanded) below, the timekeeping system can be configured to have a low data security confirmation/validation process, with nominal datapoint checks between Data Set 1 and Data Set 3, or a high data security confirmation process, with many more datapoint checks between Data Set 1 and Data Set 3. The data sets may be configured in various combinations.

The server determines whether the decoded cryptographic marker from Data Set 3 matches the cryptographic marker sent to the worker phone as Data Set 2 and, in a match, validates or confirms the first data set as being accurate, secure and authenticated data (validating the worker identifier, the worker geolocation, and the timestamp) and also verifies the manager identifier (typically, at least, the manager device ID). Server 14 generates and sends, to the worker phone, a worker confirmation and generates and sends, to the manager phone/tablet, the worker confirmation. This is the nominal Date Set 5 and 6.

The server may generate and send, to the worker phone, a confirmation of the worker identifier (worker name), the worker geolocation at the time of check-in or clock-in), and the check-in or clock-in timestamp. It should be noted that the worker clock-out process is nearly identical to the worker clock-in process described in detail herein. At clock-in, the server also generates and sends, to the manager phone/tablet, a manager confirmation of the worker identifier, the worker geolocation at check-in time, and the worker's timestamp. Additionally, the server stores the worker confirmation, the manager confirmation, the manager identifier, the worker identifier, the worker geolocation, and the timestamp in a secure data store 16 which is telecommunicatively coupled to the server 14. The worker confirmation may be a validated worker ON shift status indicator. Typically, the confirm/validation code is displayed to the employee/worker as a visual check-in confirmation.

As indicated in the Data Set-Process Flow Table above, the manager App 12 on the phone/tablet 22 may generate a second crypto marker or signature. This adds another layer of security to the timekeeping data acquisition and data transfer process. Also, the worker and the manager may want the confirmation/validation Data Sets 5-6 to include employee/worked shift data and facility data (such as healthcare facility data HC-Fac). The manager would like a visual display on display screen 42 showing worker name, worker shift data, pay rate, other shift data such as the skill level of the worker (in healthcare, this is RN, Therapist, Surgical RN, certified healthcare worker data, etc.), the skills required data, the beginning and the end times of the shift, and the facility data (HC-Fac). The check-out or the clock-out process operates in the same manner as the check-in except end-of-shift data is collected, displayed and processed.

Exemplary Process Flow Table
Step One: Employee Requests QR Code: The Employee App sends a request
to the SP Server for a QR code (a QR code request). This Data Set 1 from
Empee phone includes Employee Name/Phone, Employee Geolocation,
Employee Timestamp, Facility Name, Shift ID, Shift Start Time, Shift End
Time, Shift Pay Rate.
Step Two: SP Server Generates QR Code Data: The SP Server generates
Data Set 2, which includes all information in Data Set 1 plus a cryptographic
signature.
Step Three: SP Server Sends QR Code Data to Employee App: The SP
Server sends the generated QR code data back to the Employee App.
Step Four: Employee App Displays QR Code: The Employee App displays
the QR code on the employee's smartphone screen.
Step Five: Manager Scans QR Code: The Manager App scans the QR code
from the Employee App, utilizing the smartphone's camera.
Step Six: Manager App Sends Data to SP Server: The Manager App creates
Data Set 3, which includes all information in Data Set 2, plus the Manager
ID, Manager Name, Manager Geolocation, Manager Timestamp, and sends
this data back to the SP Server for validation.
Step Seven: SP Server Validates Manager Data: The SP Server validates
Data Set 3 by comparing the data against the employee, manager, and shift
data stored in the database.
Step Eight: SP Server Stores Validated Data in Database: If validation is
successful, the SP Server stores Data Set 3 into the database as evidence that
the manager has signed off on the shift start or shift end event.
Step Nine: SP Server Informs Employee: The server sends messages to
Employee app with the success or failure of the validation
Step Ten: SP Server Informs Manager: The server sends messages to
Manager app with the success or failure of the validation

As noted in the Exemplary Process Flow Table above, Step Six-Data Set 3 includes all information in Data Set 2, plus the Manager ID, Manager Name, Manager Geolocation, Manager Timestamp, and sends this data back to the SP Server for validation. The additional data (Mgr geoloc and Mgr timestamp) further increases the security and authenticity of the timekeeping program. The Exemplary Process Flow Table above has ten steps, Steps 1-10.

Process Flow Table (Expanded) below lists additional data collection variations and optional processes which may be employed in the cryptographically secure, realtime employee-worker timekeeping and reporting method and system.

Process Flow Table (Expanded)
Step One: Empee, via Empee App, requests QR Code from SP Server.
Empee cell phone sends Data Set 1 (Empee Name/Ph; Empee GeoLoc;
Empee T-stamp) to SP Server.
Step Two: SP Server generates QR Code and Data Set 2 (1st Crypto-Siggy;
e-Empee Name/Ph; e-Empee Shift; e-Empee GeoLoc; e-Empee T-stamp; e-
Empee H-Fac (optional); misc data (encrypt)). Data Set 2 embedded and
represented by the Server-generated QR Code. SP Server sends encrypted
QR Code to Empee Cell Phone
Step Three: As a Physical Event, Empee finds Mgr and visually presents QR
Code (and encrypted data) from Empee's Cell Phone to Mgr's Cell
Phone/Mgr Tablet. Mgr Cell Phone/Tablet opens the visually presented QR
Code.
Step Four: Mgr Cell Phone/Tablet contacts SP Server via the presented QR
Code. Optionally, SP Server partly decodes Date Set 2 (Empee Name/Ph;
Empee Shift; Empee GeoLoc (optional); Empee T-stamp; Empee H-Fac
(optional); misc data). SP Server effects the display on Mgr Cell
Phone/Tablet: Empee Name/Ph; Empee Shift; Empee GeoLoc (optional);
Empee H-Fac (optional); Empee T-stamp; misc data. Mgr Phone/Tablet
supplements the transmission of Data Set 2 to the SP Server by adding Mgr
Name/Ph; Mgr GeoLoc; Mgr T-stamp; 2nd Crypto-siggy (optional). The data
process resultant being Data Set 3 (effectively Data Set 2 embodied in the
QR code PLUS Mgr Name/Ph; Mgr GeoLoc; Mgr T-stamp; 2nd Crypto-
siggy (optional))
Step Four (Simplified): Mgr Cell Phone/Tablet contacts SP Server via the
presented QR Code and the QR Code represents Data Set 2 (Empee
Name/Ph; Empee Shift; Empee GeoLoc (optional); Empee T-stamp; Empee
H-Fac (optional); misc data). By activation of the Mgr App on the Mgr Cell
Phone/Tablet, Mgr Phone/Tablet transmits to SP Server supplemental
manager data (Mgr Supple Data: Mgr Name/Ph; Mgr GeoLoc; Mgr T-
stamp). The data processing result being Modified Data Set 3 (Data Set 2
(represented by QR code) PLUS Mgr Name/Ph; Mgr GeoLoc; Mgr T-stamp)
Step Five: SP Server decodes Data Set 3 (Data Set 2 PLUS Mgr Name/Ph;
Mgr GeoLoc; Mgr T-stamp; 2^{nd} Crypto-siggy (optional)) or decodes
modified/simplified Data Set 3 (Data Set 2 PLUS Mgr Supple Data (Mgr
Name/Ph; Mgr GeoLoc; Mgr T-stamp)). SP Server validates at least the 1^{st}
Crypto-Siggy (and optionally the 2^{nd} Crypto-Siggy) and the Empee
Name/Ph; Empee Shift; Empee GeoLoc; Empee T-stamp; Mgr Name/Ph;
Mgr GeoLoc; Mgr T-stamp; and misc data. The SP Server matches and
confirms at least 1^{st} Crypto-Siggy and the Empee Name/Ph; Empee Shift;
Empee GeoLoc; and Empee T-stamp based upon data stored in SP Server
database. Optionally, SP Server matches and confirms Mgr Name/Ph; Mgr
GeoLoc; Mgr T-stamp; and misc data. If a 2^{nd} Crypto-Siggy is used
(generated by the Mgr App), this adds an additional layer of security on the
data acquisition and transmission process. The validated data is either a
“nominal” Data Set 4 (validated 1^{st} Crypto-Siggy; Empee Name/Ph; Empee
Shift; Empee GeoLoc; Empee T-stamp; Mgr Name/Ph; Mgr GeoLoc
(optional); Mgr T-stamp (optional); misc) or a more “fulsome” Data Set 4
(validated 1^{st} Crypto-Siggy and 2^{nd} Crypto-Siggy; Empee Name/Ph; Empee
Shift; Empee GeoLoc; Empee T-stamp; Mgr Name/Ph; Mgr GeoLoc; Mgr T-
stamp; misc).
Step Six: SP Server uploads validated nominal or fulsome Data Set 4 to the
Secure Database.
Step Seven: SP Server generates Data Set 5 (Validation Empee Confirm;
Empee Name/Ph; Clock-in T Confirm (or Clock-out T); Empee Shft; H-Fac
Loc Data (optional)) and sends Data Set 5 to the Empee Cell Phone.
Step Eight: SP Server generates Data Set 6 (Validation Mgr Confirm; Mgr
Name/Ph; Empee Name; Empee Clock-in/out T Confirm; Empee Shft; H-Fac
Loc Data (optional) and sends Data Set 6 to the Mgr Phone/Tablet).

FIG. 4 shows that memory 60 in server 14 includes preloaded worker data “HC-W data” (as an example, healthcare worker “HC-W” name), HC-W phone data (may be worker cell phone number or device ID), shift identifier data including shift projected time-start and shift projected time-end (Shift ID, t in/out), Shift Mgr data (name, status of manager), Worker Pay rate, name of the facility (HC-Fac) (may also be HC-Fac and hospital ward data (ICU, CCU, RN station, etc.), Mgr Phone (phone number or device ID), Mgr ID data (manager name or manager issued ID), and other miscellaneous data. It should be noted that the server memory 60 may include much more data than listed in these Figures, such as previous work history for the worker, various pay rates for the worker based upon hospital ward data, and various worker qualifications or certifications.

The server memory is preloaded with a stored worker identifier, a stored worker phone device ID, a stored prescient worker geolocation (this datapoint being where the worker should be at the beginning of the shift, hence a “prescient” location), a stored worker shift data (what shift or shifts has the worker been assigned to or elected to work), a stored worker clock-in time (also, in a robust system, the clock-out time), a stored manager identifier data, and a stored manager phone device ID. Once the worker phone sends Data Set 1 to the server, the server engages match module 58, operating with the server processor 50, which: (a) confirms the worker identifier, the worker phone device ID, and the worker shift data with the stored worker identifier, the stored worker phone device ID, and the stored worker shift data; (b) substantially confirms the current timestamp with the stored worker clock-in time; (c) substantially confirms the current worker geolocation with the stored prescient worker geolocation; and (d) generates an initial worker ON shift status data. The data processing uses preloaded worker shift data as a further security enhancement of the timekeeping program. Once the match (function 58, FIG. 4) confirms the data, the server generates an initial worker ON shift status datapoint. This is “initial” ON-shift datapoint because the input data from worker phone 20 has not yet been confirmed or validated by the manager phone/tablet or the second validation function 18 in FIG. 2.

The term “substantially confirms” includes the concept that the worker's timestamp or Clock-in time must be different than the managers phone/tablet timestamp generated when the QR code is scanned by the manager phone/tablet. It is impossible for the worker clock-in time to be the same as the manager timestamp captured at the time or near the time the manager's phone/tablet receives the lighted QR code from the worker phone. Hence, “substantially confirms” means that some reasonable time differentials are accounted for by the method and the system. For example, the worker must locate and illuminate the manager phone/tablet with the QR code within a time differential of 5-10 minutes after the worker clocks-into the timekeeping system. This time differential or variable is set by the system operator. The same concept applies to gathered geolocation data because, most likely, the geolocation of the worker at the time of clock-in may be different than the geolocation of the manager at the time or QR code receipt, especially if the worker and manager are located in different parts of the building or work location. The geolocation differential is highly dependent upon the size of the facility and the typical distance between the worker and the manager.

The cryptographic generator 54, associated with the server processor 50 and the server memory 60, generates a cryptographic marker based upon one or more of the worker phone device ID, the current worker geolocation or the initial ON shift status. A more robust and secure system uses all three datapoints for the crypto keycode hash. The server processor, in conjunction with the cryptographic generator, generates a two-dimensional barcode (QR code) representation using data from the cryptographic marker and the one or more of the worker phone device ID, the current worker geolocation or the initial ON shift status. The QR code further encodes embedded data and secures data transferred in Data Set 2 to the phone 20. The worker phone processor 36 receives and stores the QR barcode representation and, under the manual control of the worker, permits the worker to activate the worker phone display 34 to project a lighted QR barcode based upon the QR barcode representation. In other words, the QR code is displayed on the worker phone display. The “QR barcode representation” is the digital format for the QR code because the “QR code” is a visual presentation viewable by humans whereas the “representation” is a data string.

When the worker phone 20 is adjacent to the manager phone/tablet 22 (graphically illustrated in FIGS. 1 and 4), the lighted QR barcode illuminates the manager camera 46 and thereby visually transfers the QR barcode from the worker phone to manager phone/tablet. The lighted QR barcode either (i) triggers the manager phone/tablet processor 40 to generate a manager data set (that set including a manager device ID, a manager timestamp, a captured representation of the visually transferred QR barcode), and sends the manager data set to the server or (ii) triggers the manager phone/tablet 22 to contact server 14 and the server engages a subprogram on the Manager App 12 to perform the functions in item (i) above. The lighted QR barcode becomes a captured two-dimensional barcode because phone/tablet 22 captures the data and creates a digital representation of the data, hence, a data capture.

The server has a cryptographic decoder 56 which receives and decodes the captured QR barcode and the encoded worker data set. The server then generates a representation of the cryptographic marker and a decoded worker data set. The match module 58, in the server 14, authenticates (i) the decoded worker data set by comparing the representation of the cryptographic marker with the cryptographic marker, and (ii) the manager data set by comparing the stored manager phone device ID with the manager phone device ID. Again, the “representation” is a digital version of the crypto marker or signature. The server processor validates the initial worker ON shift status as a validated worker ON shift status based upon the match module authenticating the decoded worker data set, the cryptographic marker, and the manager data set. The match function 58 compares the preloaded worker data in memory 60 with the then gathered data in Data Sets 2 and 3. The server processor then sends to the worker phone the validated worker ON shift status. The server processor also sends to the manager phone/tablet the validated worker ON shift status.

If the worker has a employer issued id (issued by the employer or contracting party), and the manager has a manager issued id, the camera on the worker's phone manager's phone/tablet permits the worker/manager to scan the employer/contractor issued id with a phone camera. In response to the scanned employer issued id, the server generates the cryptographic marker based upon the employer issued id. This use of a worker scanned employer issued id further enhances the security and veracity of the gathered data from the worker. Also, the manager scans the manager issued id with the his/her phone/tablet camera, and the server obtains the manager issued id and verifies the manager issued id while validating the first data set. This use of a manager scanned manager issued id to further enhance the security and veracity of the gathered data from the manager.

In the drawings, and sometimes in the specification, reference is made to certain abbreviations. The following Abbreviations Table provides a correspondence between the abbreviations and the item or feature.

Abbreviations Table

| | |
|---|---|
| addr | address - typically an address, street, city, state, zip |
| API | application program interface |
| App | downloaded application on mobile device |
| ASP | application service provider - server on a network |
| auto | automatic, without manual activation, maybe a pre-set |
| | condition, set by the system operator, prior to use of |
| | functional program |
| cmd | command |
| cntl | control or controller |
| comm. | communications, typically telecommunications |
| comp | computer having internet enabled communications module |
| Crypt-siggy | cryptographic signature |
| DB | data base |
| Displ | display, typically data shown on a monitor or display |
| | screen of a computer-enabled device, may be an interactive |
| | data input screen displayed to the operator/agent, or may be |
| | an output report displayed on the same screen, typically |
| | display a web page or display certain information. |
| e | encryption or encrypted, such as encrypted data |
| e.g. | for example |
| Empee | employee; “Empee Name/Phone” indicates the employee |
| Empr | employer or potential employer |
| Fac | facility, such as a Healthcare Facility |
| fnc | function, typically a computer function |
| Gen | Generator, a module that generates a defined output given |
| | certain inputs |
| GeoLoc | geographic location data or code (geo.loc. is GPS data) |
| GPS | geo positioning system and location (optionally time data) |
| HC-Fac | Healthcare Facility, hospital, clinic, surgical center |
| HC-W | healthcare worker |
| Hosp | hospital or any other type of healthcare facility such as a |
| | clinic, doctor's office, nurse registry, temp agency for |
| | healthcare workers, etc. |
| I/O | input/output |
| id | identify or identification |
| ie or IE | Internet-enabled device, like a smart phone, |
| | tablet computer, computer, etc. |
| IP addr. | internet protocol address of internet enabled device |
| kyPd | keypad or touch screen display acting as a keypad |
| kyBd | keyboard or a touch screen display function |
| loc | location |
| med | medical, as in medical data |
| mess | message as in SMS or text message |
| misc | miscellaneous, as in additional misc data transmitted |
| | between devices |
| Mgr | manager, such as a manager at a HC-Fac |
| mod | modify or modification |
| ntwk | network, namely a telecomm network, typically the internet |
| | network. A local area network is also possible. |
| obj | object, for example, a data object |
| opt | optional or alternative program or module |
| pgm | program |
| Ph | phone, namely an internet enabled phone, such as a smart |
| | phone |
| Ph. no. | phone number |
| Pty | party engaged in telecomm or internet enabled |
| | communications |
| P/W | password |
| rcd | database record or record profile |
| re | regarding or relating to |
| rel | release |
| rem | reminder, such as a reminder email to the HC-W |
| RQT | request |
| rev | review |
| Rpt | Report |
| rt | real time, may include day and time stamp data |
| sch | search |
| sel | select |
| sess | session, as in telecomm session between an agent and a |
| | customer |
| Shft | Shift, as in a Healthcare worker (HC-W) work shift |
| smart ph | smart phone coupled to the internet |
| sms | text message |
| SP | Service Provider, e.g., an entity providing nurses on a |
| | contractual basis to a HC-FAC |
| stat | static |
| std | standard, typically protocol set by a group and accepted by |
| | the system operator |
| Supple | supplement, e.g., to add data to a data transmission |
| Svr | sever, as in web server |
| sys | system |
| Sys Op | System Operator |
| t | time |
| t in/out | clock-in time and clock-out time |
| Tfxr | Transfer module |
| T-stamp | date/time stamp or recorded data |
| t-out | clock out time |
| t plus tx | an additional pre-set period of time added to a time-based |
| | trigger, for example, when a time-end-flag is created, the t |
| | plus tx, when tx = 3 sec., is the time stamp at time-end-flag |
| | plus 3 sec . . . |
| Tbl | tablet computer |
| telecom | telecommunications system or network |
| UPP | user's personal profile, for example an HC worker |
| | completes a UPP prior to inputting data about his or her HC |
| | application. |
| URL | Uniform Resource Locator or other network locator |
| vs | versus |
| w/ | with |
| w/in | within |
| w/out | without |
| w/r/t | with respect to |

The system described above notes that the users employ multiple Internet-enabled (IE) devices, such as, smart phone, cell phone with an App, tablet computer, desktop computer, or other IE device that is internet enabled. Computer tablets, desktop computers, and other electronic devices may be configured in this manner. The App or internet portal permits the person to access the system. If the user communicates with the system in a voice mode, the user interacts primarily with an interactive voice response system or module, an IVR. In other words, rather than manual data entry interactive voice response system IVR may be used for data input. The present invention processes data via computer systems, over the Internet and/or on a computer network (LAN or WAN), and computer programs, computer modules and information processing systems accomplish these tracking services.

The embodiments illustrated herein and described herein are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to be an ordinary skill in the art. The system, or method, according to the inventive principles as disclosed in connection with the preferred embodiment, may be produced in multiple computer systems with display screens and cameras with separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiments, the invention and the inventive principles are not limited to any particular kind of computer system, cellphone or tablet or desktop computer but may be used with any general purpose computers with display screens and cameras readers, as would be known to one of ordinary skill in the art, arranged to perform the functions described and the method steps described. The term “tablet” also refers to a desktop computer having the hardware functions described in the manager's tablet. The operations of such a computer, phone or tablet, with display screens and cameras readers, as described above, may be according to a computer program contained on a medium for use in the operation or control of the computer as would be known to be an ordinary skill in the art. The computer medium which may be used to hold or contain the computer program product, may be a fixture of the computer such as an embedded memory or may be on a transportable medium such as a disk, as would be known to be an ordinary skill in the art. Further, the program, or components or modules thereof, may be downloaded from the Internet or otherwise through a computer network.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium or memory allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits. Furthermore, the computer readable medium may include computer readable information in a transitory state medium such as a network link and/or a network interface, including a wired network or a wireless network, or a cloud-based system that allow a computer to read such computer readable information.

Those of skill in the art will appreciate that the various illustrative modules, components, engines, and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, components, engines, and method steps described in connection with the embodiments disclosed herein can be implemented or performed with hardware such as a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor is hardware and can be a microprocessor, but in the alternative, the processor can be any hardware processor or controller, microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm and the functionality of a component, engine, or module described in connection with the embodiments disclosed herein can be embodied directly in hardware, in software executed by a processor, or in a combination of the two. Software can reside in computer or controller accessible computer-readable storage media including RAM memory, flash memory, ROM memory, EPROM memory, EEPROM memory, registers, hard disk, a removable disk, a CD-ROM, or any other form of storage medium including a network storage medium and cloud-based systems. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims. The claims appended hereto are meant to cover modifications and changes within the scope and spirit of the present invention.

What is claimed is:

1. A cryptographically secure, realtime worker timekeeping and reporting method comprising:
in conjunction with a worker cell phone, a manager cell phone or tablet and a server, all telecommunicatively coupled together, the worker phone having a display, and the manager phone or tablet having a display screen and a camera;
from the worker phone, sending a first data set to the server, the first data set including a worker identifier, a worker geolocation, and a timestamp;
at the server, generating a cryptographic marker unique to at least one or more of the worker identifier, the worker geolocation, or the timestamp, and generating a two-dimensional barcode based upon the cryptographic marker and at least one or more of the worker identifier, the worker geolocation, or the timestamp;
sending the two-dimensional barcode from the server to the worker phone;
physically placing worker phone display proximate the manager phone or tablet camera and visually transferring the two-dimensional barcode from the worker phone to manager phone or tablet;
in response to the two-dimensional barcode, establishing a telecommunications link between the manager phone or tablet and the server;
at the server:
obtaining, from the manager phone or tablet, a manager identifier and the two-dimensional barcode, and thereafter decoding the two-dimensional barcode to obtain a decoded cryptographic marker;
determining whether the decoded cryptographic marker matches the cryptographic marker and, in a match, validating the first data set, the worker identifier, the worker geolocation, and the timestamp and also verifying the manager identifier;
generating and sending, to the worker phone, a worker confirmation of one or more of the worker identifier, the worker geolocation, and the timestamp;
generating and sending, to the manager phone or tablet, a manager confirmation of the worker identifier, the worker geolocation, and the timestamp; and,
storing the worker confirmation, the manager confirmation, the manager identifier, the worker identifier, the worker geolocation, and the timestamp in a secure data store telecommunicatively coupled to the server.

2. The realtime worker timekeeping and reporting method as claimed in claim 1 wherein the generation of the cryptographic marker is unique to the worker identifier, the worker geolocation, and the timestamp.

3. The realtime worker timekeeping and reporting method as claimed in claim 1 wherein generating the two-dimensional barcode is based upon the cryptographic marker, the worker identifier, the worker geolocation, and the timestamp.

4. The realtime worker timekeeping and reporting method as claimed in claim 1 wherein the two-dimensional barcode is a QR code.

5. The realtime worker timekeeping and reporting method as claimed in claim 1 wherein the worker identifier is a worker name, an employer issued id, or a worker's phone device ID, and wherein the manager identifier is a manager name, a manager issued id, or a manager's phone or tablet device ID.

6. The realtime worker timekeeping and reporting method as claimed in claim 5 wherein the worker's phone has a phone camera, and the worker identifier is the employer issued id, the manager identifier is the manager issued id, and the method includes:
the worker scanning the employer issued id with the phone camera and the server generating the cryptographic marker based upon the employer issued id;
the manager scanning the manager issued id with the phone or tablet camera, and the server obtaining the manager issued id and verifying the manager issued id while validating the first data set.

7. The realtime worker timekeeping and reporting method as claimed in claim 1 wherein the server has a server data store distinct from the secure data store and the method includes:
the server data store storing the worker identifier, a worker name, a employer issued id, and a worker's phone device ID;
the server data store storing preloaded worker shift data, preloaded worker geolocation data for the shift, and preloaded facility data for the preloaded worker shift;
the server data store storing the manager identifier, a manager name, and a manager's phone device ID and storing preloaded manager shift data;
when the first data set is sent to the server, the server obtains the worker's phone device ID to determine a match with the stored worker's phone device ID, and a proximate match with the preloaded worker shift data and the timestamp, and further proximately matches the worker geolocation with either the preloaded worker geolocation data for the shift or the preloaded facility data for the shift;
once the first data set matches the preloaded data and the stored worker's phone device ID, the server generates the cryptographic marker and the two-dimensional barcode;
the server, in determining validation of the first data set, proximately matches the worker geolocation and preloaded worker geolocation data for the shift and the preloaded facility data, and proximately matches the timestamp with the preloaded worker shift data, and matches the worker's phone device ID with the stored worker's phone device ID; and
the server, in verifying the manager identifier proximately matches the timestamp with the preloaded manager shift data.

8. The realtime worker timekeeping and reporting method as claimed in claim 7 wherein the server generates and sends, to the worker phone, the worker confirmation, the worker name, the worker identifier, the employer issued id, the worker geolocation, and the timestamp; and, the server generates and sends, to the manager phone or tablet, the manager confirmation of the worker identifier, the worker geolocation, the timestamp and the preloaded worker shift data, and further sends the manager identifier and the manager name to the manager.

9. The realtime worker timekeeping and reporting method as claimed in claim 7 wherein the preloaded worker shift data includes skills required data and worker pay rate data;
the server, in addition to sending the manager confirmation of the worker identifier, the worker geolocation, and the timestamp also sends the worker name, the worker assigned id, the skills required data and the worker pay rate data.

10. In combination with a worker cell phone, a manager cell phone or tablet and a server, all telecommunicatively coupled together via a network, wherein the worker phone has a worker display and the manager phone or tablet has a manager display screen and a camera, a cryptographically secure, realtime worker timekeeping and reporting system comprising:
a worker phone processor compiling a worker data set including a worker identifier, a worker phone device ID, a current worker geolocation, a worker shift data, and a worker current timestamp stored in a worker phone memory;
a worker phone interface sending the worker data set to the server via the network;
the server having a server processor accessing a server memory preloaded with a stored worker identifier, a stored worker phone device ID, a stored prescient worker geolocation, a stored worker shift data, a stored worker clock-in time, a stored manager identifier data, and a stored manager phone device ID;
a server network interface accepting the worker data set;
a match module, operating with the server processor, which: (a) confirms the worker identifier, the worker phone device ID, and the worker shift data with the stored worker identifier, the stored worker phone device ID, and the stored worker shift data; (b) substantially confirms the current timestamp with the stored worker clock-in time; (c) substantially confirms the current worker geolocation with the stored prescient worker geolocation; and (d) generates an initial worker ON shift status;
a cryptographic generator, coupled to the server processor, operating on one or more of the worker identifier, the worker phone device ID, the worker shift data, the current worker geolocation or the initial ON shift status, and generating an encoded worker data set and a cryptographic marker both embodied by a two-dimensional barcode representation;
the server network interface sending the two-dimensional barcode representation to the worker phone interface via the network;
the worker phone processor storing the two-dimensional barcode representation and activating the worker phone display to project a lighted two-dimensional barcode based upon the two-dimensional barcode representation;
the lighted two-dimensional barcode illuminating the manager camera and thereby visually transferring the two-dimensional barcode from the worker phone to manager phone or tablet;
a manager network interface in the manager phone or tablet and, in response to the lighted two-dimensional barcode, establishing a telecommunications link between the manager phone or tablet and the server via the network;
a manager processor, in the manager phone or tablet, generating a manager data set including a manager identifier, a manager device ID, a manager timestamp, a captured representation of the visually transferred two-dimensional barcode, and sending the manager data set to the server via the manager network interface;
a cryptographic decoder, coupled to the server processor, decoding the captured two-dimensional barcode and the encoded worker data set and generating a representation of the cryptographic marker and a decoded worker data set;
the server processor storing, in the server memory, the manager data set, the generated representation of the cryptographic marker, and the decoded worker data set;
the match module authenticating (i) the decoded worker data set by comparing the representation of the cryptographic marker with the cryptographic marker, and (ii) the manager data set by comparing the stored manager identifier data and the stored manager phone device ID with the manager identifier data and the manager phone device ID;
the server processor validating the initial worker ON shift status as a validated worker ON shift status based upon the match module authenticating the decoded worker data set, the cryptographic marker, and the manager data set and storing, in the server memory, the validated worker ON shift status with the decoded worker data set and the manager data set;
the server processor sending to the worker phone, via the server network interface, the validated worker ON shift status; and
the server processor sending to the manager phone or tablet, via the server network interface, the validated worker ON shift status.

11. The combination of the worker cell phone, the manager cell phone or tablet and the server for the cryptographically secure, realtime worker timekeeping and reporting system as claimed in claim 10 wherein the cryptographic generator generates the cryptographic marker based upon all or a portion of the worker data set.

12. The combination of the worker cell phone, the manager cell phone or tablet and the server for the cryptographically secure, realtime worker timekeeping and reporting system as claimed in claim 10 wherein the two-dimensional barcode is a QR code.

13. The combination of the worker cell phone, the manager cell phone or tablet and the server for the cryptographically secure, realtime worker timekeeping and reporting system as claimed in claim 10 wherein the worker identifier is a worker name, an employer issued id, or the worker phone device ID, and wherein the manager identifier is a manager name, a manager issued id, or the manager device ID.

14. The combination of the worker cell phone, the manager cell phone or tablet and the server for the cryptographically secure, realtime worker timekeeping and reporting system as claimed in claim 13 wherein the worker's phone has a phone camera coupled to the worker processor, and the worker identifier is the employer issued id, the manager identifier is the manager issued id;
the server memory preloaded with the employer issued id and the manager issued id;
the phone camera and the worker processor, upon scanning the employer issued id, sends the worker identifier to the server;
the server processor and cryptographic generator generating the cryptographic marker based upon the employer issued id represented by the worker identifier;
the camera, in the manager phone or tablet, upon scanning the manager issued id, sends the manager identifier to the server; and
the match module authenticating the decoded worker data set by comparing the employer issued id with the stored employer issued id and by comparing the stored manager issued id with the manager issued id.

15. The combination of the worker cell phone, the manager cell phone or tablet and the server for the cryptographically secure, realtime worker timekeeping and reporting system as claimed in claim 10:
the server processor, upon validation of the validated worker ON shift status, generates a validated worker data set including the worker identifier, the current worker geolocation, the worker shift data, and the earlier worker current timestamp and sends the validated worker data set to the worker phone via the network; and
the server processor, upon generation of the validated worker data set, sends the validated worker data set to the manager phone or tablet with the validated worker ON shift status.

16. Combination of the worker cell phone, the manager cell phone or tablet and the server for the cryptographically secure, realtime worker timekeeping and reporting system as claimed in claim 15 wherein the preloaded worker shift data includes preloaded skills required data and preloaded worker pay rate data;
the server processor includes, as part of the validated data set, the preloaded skills required data and preloaded worker pay rate data.

17. A cryptographically secure, realtime worker timekeeping and reporting system comprising:
a worker cell phone, a manager cell phone or tablet and a server, all telecommunicatively coupled together via a network;
the worker phone having a worker phone display, a worker phone processor, and a worker phone memory, the worker processor compiling a worker data set including a worker phone device ID, a current worker geolocation, and a worker current timestamp from data stored in the worker memory;
the worker processor sending the worker data set to the server via the network;
the server having a server processor accessing a server memory preloaded with a stored worker phone device ID, a stored prescient worker geolocation, a stored worker clock-in time, and a stored manager phone device ID;
a match module associated with the server processor and the server memory (a) confirming the worker phone device ID with the stored worker phone device ID, (b) substantially confirming the current timestamp with the stored worker clock-in time; (c) substantially confirming the current worker geolocation with the stored prescient worker geolocation; and (d) upon such confirmation, generates an initial worker ON shift status;
a cryptographic generator associated with the server processor and the server memory, generates a cryptographic marker based upon one or more of the worker phone device ID, the current worker geolocation or the initial ON shift status and generates a two-dimensional barcode representation with the cryptographic marker and the one or more of the worker phone device ID, the current worker geolocation or the initial ON shift status;
the worker phone processor receiving and storing the two-dimensional barcode representation and activating the worker phone display to project a lighted two-dimensional barcode based upon the two-dimensional barcode representation;
the manager phone or tablet having a manager display screen and a camera, a manager processor and a manager memory;
the lighted two-dimensional barcode illuminating the manager camera and thereby visually transferring the two-dimensional barcode from the worker phone to manager phone or tablet;
the lighted two-dimensional barcode triggering the manager processor to generate a manager data set including a manager device ID, a manager timestamp, a captured representation of the visually transferred two-dimensional barcode and send the manager data set to the server;
a cryptographic decoder, coupled to the server processor, receiving and decoding the captured two-dimensional barcode and the encoded worker data set and generating a representation of the cryptographic marker and a decoded worker data set;
the match module authenticating (i) the decoded worker data set by comparing the representation of the cryptographic marker with the cryptographic marker, and (ii) the manager data set by comparing the stored manager phone device ID with the manager phone device ID;
the server processor validating the initial worker ON shift status as a validated worker ON shift status based upon the match module authenticating the decoded worker data set, the cryptographic marker, and the manager data set;
the server processor sending to the worker phone the validated worker ON shift status; and
the server processor sending to the manager phone or tablet the validated worker ON shift status.

18. The cryptographically secure, realtime worker timekeeping and reporting system as claimed in claim 17 wherein the server memory has preloaded stored worker shift data including pay rate and shift worker requirements;
the server processor, upon generation of the validated worker ON shift status, further generates a worker validation data set including a worker identifier, the current worker geolocation, the worker current timestamp, the pay rate, and the shift worker requirements, and sends the worker validation data set to the worker phone;
the server processor sends the worker validation data set with the validated worker ON shift status to the manager phone or tablet.
